(19) United States
(12) Patent Application Publication
(10) Pub. No.: US 2007/0119653 A1
(43) Pub. Date: May 31, 2007

(54) Fall arrest device and system incorporating the same

(76) Inventors: Kevin Brown, Warrington (GB); Luke Stratton, Kidderminster (GB)

Correspondence Address: Ira S Dorman, 330 Roberts Street, Suite 200, East Hartford, CT, 06108, US

(21) Appl. No.: 10/576,436

(22) PCT Filed: Oct. 11, 2004
(86) PCT No.: PCT/GB04/04294

§ 371 Date: Nov. 3, 2006

(30) Foreign Application Priority Data
Oct. 21, 2003 (GB) 0324495.1
Aug. 28, 2004 (GB) 0419225.8

(51) Int. Cl. A62B 1/16

(52) U.S. Cl. 182/36; 182/5

(57) ABSTRACT

A fall arrest device includes a U-shaped member (3, 5) adapted to accommodate a track (7) of a fall arrest system. A cam member (15, 17; 81, 83; 87, 89), including an actuating arm (21; 85) and a cam portion (19), is pivotably mounted on the device such that the cam portion is movable towards the U-shaped member so as to lock the track between the cam portion and an internal surface of the U-shaped member in the event of a fall. Biasing means (22) urges the cam member to a position in which the cam portion is adapted to allow the track to pass between the cam portion and the internal surface of the U-shaped member. Actuating means (27; 93) is adapted, in the event of a fall, to engage with the actuating arm or the cam member and to cause the cam member to pivot against the biasing force of the biasing means such that the cam portion locks the track. Friction means (55) is adapted in use to engage with the track such that at least a predetermined minimum load is required to cause the device to move relative to the track.

This invention relates to a fall arrest device which is adapted to be mounted on a fixed track, which may be, for example, a cable or a rail. Such a device may be used in conjunction with vertical, inclined or horizontal fall arrest systems. The invention also relates to a fall arrest system incorporating such a device.

It is well known in fall arrest systems to provide a fall arrest device which allows a user to attach to the fall arrest system at any point along its length while allowing the user to remain attached whilst traversing the cable, including passing any intermediate supports for the cable. In the event of a slip or a fall from a structure to which the fall arrest system is attached, a load is applied to the device and the device locks onto the cable.

It is generally desirable that a fall arrest device should be detachable from the cable or rail of the fall arrest system for a number of reasons. For example, the fall arrest device may be detachable to minimise the number of such devices that may be required and also to deter unauthorised use of the fall arrest system.

Vertical fall arrest systems are provided, for example, on pylons or towers, while horizontal fall arrest systems are generally provided on the roofs of structures and inclined fall arrest systems may be provided on barrel roofs and window cleaning gantries.

Detachable fall arrest devices for fall arrest systems are well known. For example, U.S. Pat. No. 6,019,195 and U.S. Pat. No. 6,263,999 both describe such devices which employ a cam mechanism which is adapted to lock onto a cable in the event of a fall.

A disadvantage of a cam mechanism is that, although the user generally has freedom when ascending a structure, when the user is descending it is often necessary to disengage the cam from the cable by altering the climbing position such that it is unnatural, for example by leaning towards the structure.

Alternatively, it is known to weight the device such that it is always below the user in order that the user does not engage the cam while descending. Although this overcomes one problem, it creates another. When the device is below the user, for example by up to 400 to 500 mm, the user will have to fall up to 1 m before the cam mechanism engages with the cable to arrest the user. Such a free fall is undesirable as it can cause trauma to the worker and generate a significant load at the top of the fall arrest system and consequently on the structure. Moreover, if the device is below the user and the user does not free fall, for example as a result of a limb becoming entangled with the structure, the fall arrest device may not lock onto the cable and this could result in serious injury to the user. This might be because the user does not fall to a level below the fall arrest device and/or does not have sufficient momentum to cause the device to lock.

It would therefore be desirable to have a fall arrest device which is able to move consistently with the user irrespective of whether they are ascending or descending.

A further disadvantage can arise when the fall arrest system is installed on an inclined surface, such as a barrel roof. Known fall arrest devices are designed to lock onto the cable in one direction only and therefore provide effective safety protection when initially travelling up the slope of the structure. However, when the apex is reached it is necessary for the user to turn the device around in order for the device to function. It is known, for example in U.S. Pat. No. 6,019,195, to provide fall arrest devices with continuous cam engagement in order to prevent any sliding when the user is not moving. However, the user is required to disengage the cam in order to travel along the fall arrest system which is inconvenient and potentially dangerous.

In the case of horizontal fall protection systems, where the angle of inclination is not more than 15 degrees, it is usual to use fall protection devices without any form of cam mechanism, thereby allowing the device to move freely along the cable. In the event of a fall, the user will generally travel to the centre of a V in the cable or will slide to the nearest intermediate anchor supporting the system. However, multi-user falls can be dangerous as collisions can occur when users slide together or slide into parts of the structure beneath them. It is therefore desirable to employ a locking fall arrest device also on a horizontal fall arrest system.

It is therefore an object of the present invention to provide a fall arrest device which overcomes, or at least ameliorates, one or more of the above disadvantages.

According to one aspect of the present invention there is provided a fall arrest device comprising:

a U-shaped member adapted to accommodate a track of a fall arrest system;

a cam member including an actuating arm and a cam portion, the cam member being pivotably mounted on the device such that the cam portion is movable towards the U-shaped member so as to lock the track between the cam portion and an internal surface of the U-shaped member in the event of a fall;

biasing means urging the cam member to a position in which the cam portion is adapted to allow the track to pass between the cam portion and the internal surface of the U-shaped member;

actuating means adapted in the event of a fall to engage with the actuating arm or the cam member and to cause the cam member to pivot against the biasing force of the biasing means such that the cam portion locks the track; and

friction means adapted in use to engage with the track such that at least a predetermined minimum load is required to cause the device to move relative to the track.

Two U-shaped members may be provided, the U-shaped members being spaced in the axial direction of the path of a track through the device.

The actuating arm of the cam member may be provided with guide flanges for the actuating means.

The device may include two cam members, the cam members being adapted to be actuated by movement of the actuating means in generally opposing directions.

The biasing means may comprise a torsion spring.

The biasing means may be adapted to maintain the cam member in position until a threshold load is applied thereto.

The actuating means may be pivotably mounted on the device.

Alternatively or additionally, the actuating means may be movable in a direction towards and away from the path of the track through the device. The actuating means may be movable in a direction substantially perpendicular to the path of the track.

The actuating means may include a lever adapted to engage the cam member. The lever may be slidably engaged with an arcuate slot provided in the cam member.

Alternatively or additionally, the actuating means may engage directly with the cam member.

The actuating means may be provided with an aperture for receiving fastening means for securing a user to the device. The device may include a plate extending in a plane substantially parallel to the actuating means and provided with an aperture for receiving the fastening means. Two spaced plates may be provided, one plate being positioned on either side of the actuating means.

The aperture in the plate may be curved. Moreover, the aperture may include a portion at least at one end thereof extending in a direction substantially parallel to the axial direction of the path of the track through the device.

An intermediate member may be provided, the intermediate member extending through the aperture in the actuating means and through the aperture in the or each plate, for connecting to a fastening means.

The friction means may comprise a cylindrical post, the axially extending surface of the post being adapted to engage the track. Two cylindrical posts may be provided, the posts being spaced in the axial direction of the path of the track through the device. The cylindrical posts may be in the region of opposite ends of the device.

The friction means may be movable towards and away from the path of the track.

The friction means may be adapted to exert a force on the track such that a predetermined minimum load is required to move the device relative to the track. The predetermined load may correspond to a load less than 5 kg. Alternatively or additionally, the predetermined load may correspond to a load greater than the weight of the device.

The friction means may include means biasing the friction means towards the path of the track. The biasing means may comprise a compression spring.

The friction means may comprise means, such as a release button, for (manually) moving the friction means away from the path of the track.

The device may include a lock plate which is (manually) movable towards and away from the path of the track through the device, the lock plate including biasing means adapted to bias the plate to a position in which it co-operates with the U-shaped member to prevent the device being removed from the track. The lock plate may be spaced from the U-shaped member in the locking position to allow the device to pass over intermediate posts of the fall arrest system. The biasing means may comprise a torsion spring. The lock plate may include a release button for moving the lock plate in a direction away from the U-shaped member against the force of the biasing means.

According to another aspect of the present invention there is provided a fall arrest system comprising a track, an intermediate bracket and a device as hereinbefore defined, wherein the intermediate bracket is formed intermediate end portions thereof with inclined faces whereby a portion of the track is exposed intermediate the end portions for engagement with the friction means and with the cam portion of the fall arrest device.

The track may be in the form of a cable.

The intermediate bracket may be formed intermediate end portions thereof with inclined faces whereby a portion of the track intermediate the end portions is exposed for engagement with the internal surface of the U-shaped member of the fall arrest device. The end portions of the intermediate bracket may be interconnected by means lateral connecting portions provided at each side of the track.

The end portions of the intermediate bracket may be formed with divergent faces, one of which faces is adapted to engage the friction means and the other of which faces is adapted to engage the internal surface of the U-shaped member.

For a better understanding of the present invention and to show more clearly how it may be carried into effect reference will now be made, by way of example, to the accompanying drawings in which:

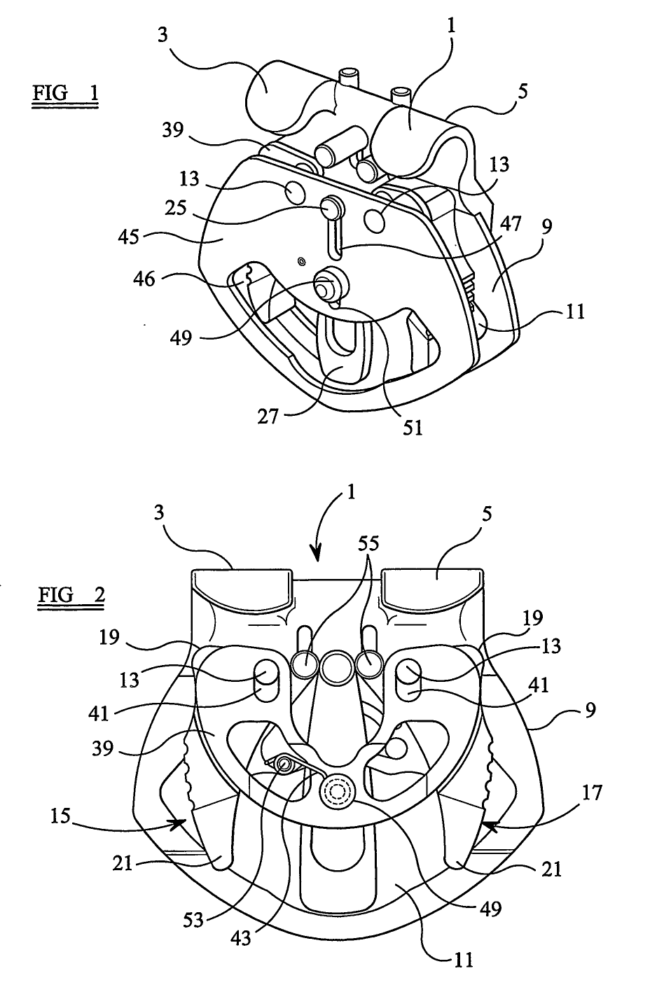

FIG. 1 is a perspective view of one embodiment of a fall arrest device according to the present invention, the device being detachable from a fall arrest system;

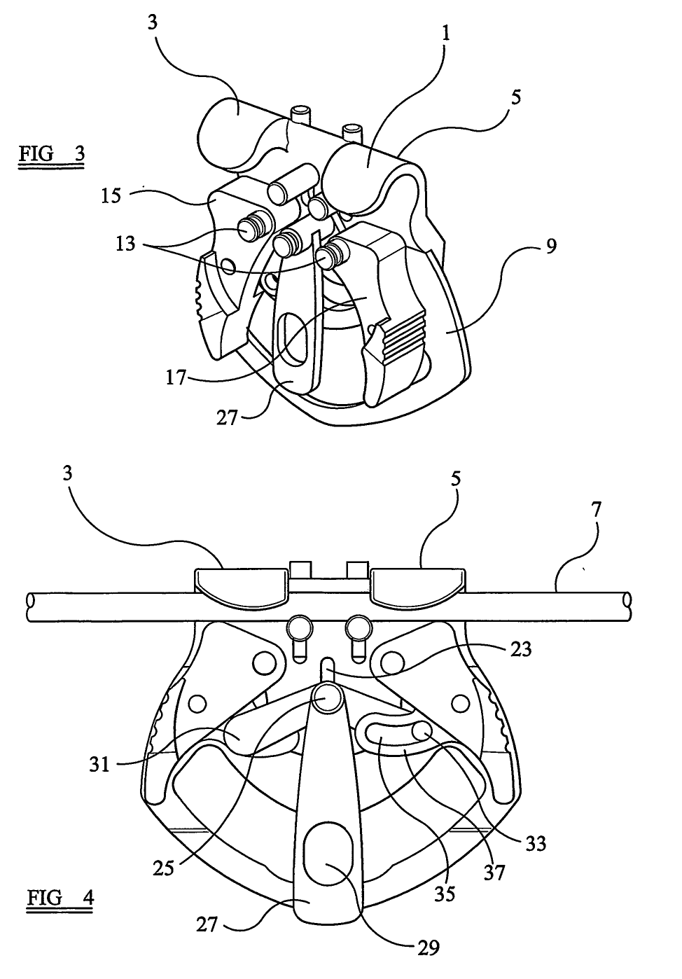

FIG. 2 is a front view of the device shown in FIG. 1 with a front plate removed;

FIG. 3 is a perspective view of the device shown in FIG. 2 with a locking plate removed;

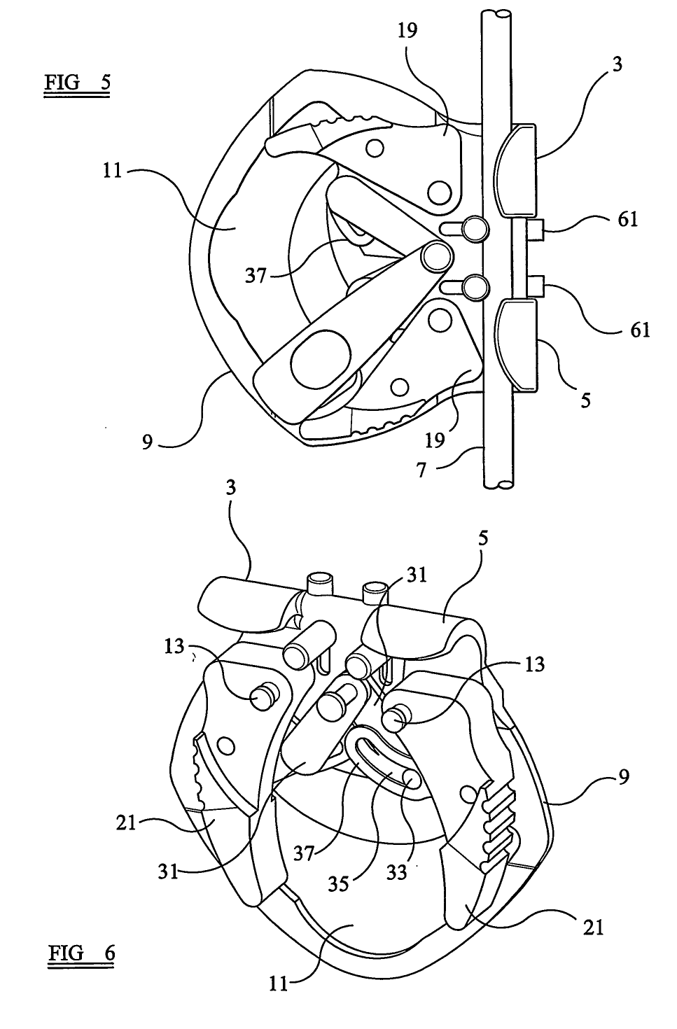

FIG. 4 is a front view of the device as shown in FIG. 3 in a deployed configuration;

FIG. 5 is a front view of the device as shown in FIGS. 4 and 5 in an alternative deployed configuration;

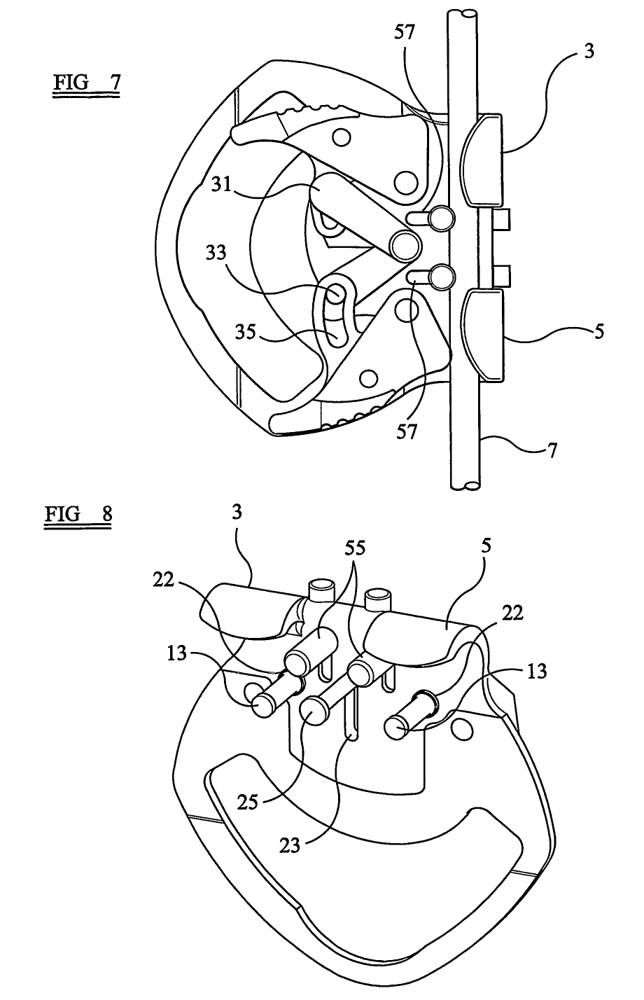

FIG. 6 is a perspective view of the device shown in FIG. 3 with a connector plate removed;

FIG. 7 is a front view of the device as shown in FIG. 6 in a deployed configuration;

FIG. 8 is a perspective view of the device shown in FIG. 6 with a cam mechanism removed;

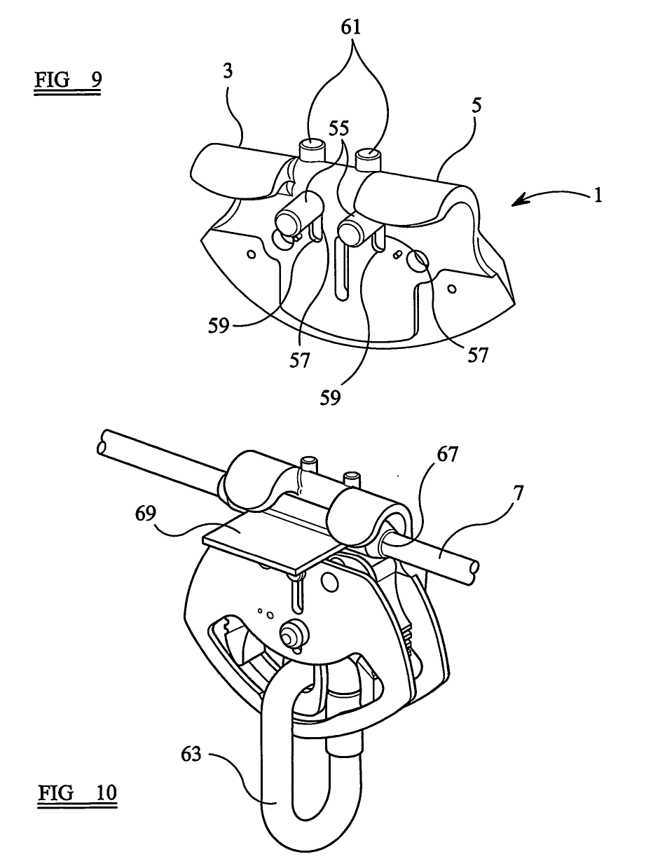

FIG. 9 is a perspective view of the device shown in FIG. 8 with a back plate removed;

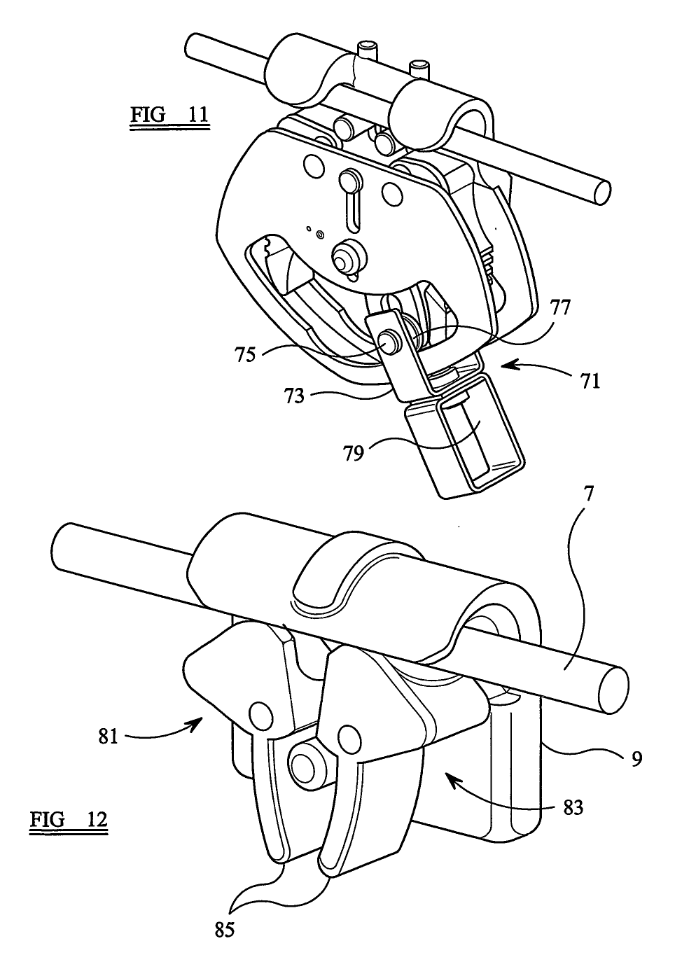

FIG. 10 is a perspective view of the device shown in FIG. 1 together with a karabiner and illustrating the manner in which the device negotiates an intermediate bracket of a fall arrest system;

FIG. 11 is a perspective view of a modification of the device shown in FIG. 1;

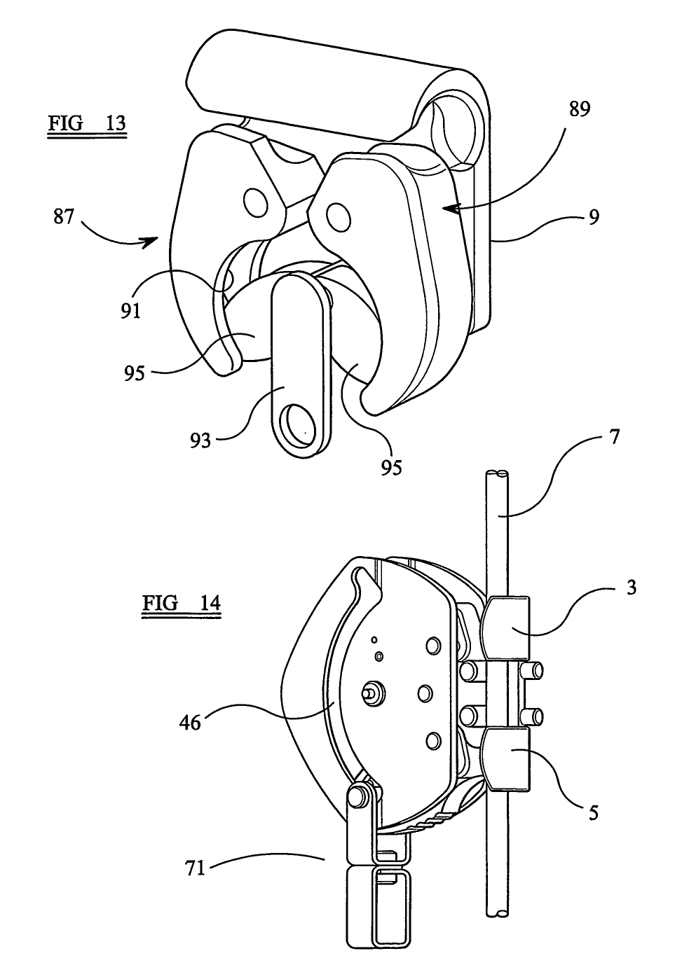

FIG. 12 is a perspective view illustrating a modification of part of the device shown in FIG. 1;

FIG. 13 is a perspective view illustrating an alternative modification of part of the device shown in FIG. 1;

FIG. 14 is a perspective view showing another embodiment of a fall arrest device according to the present invention, the device being detachable from a fall arrest system;

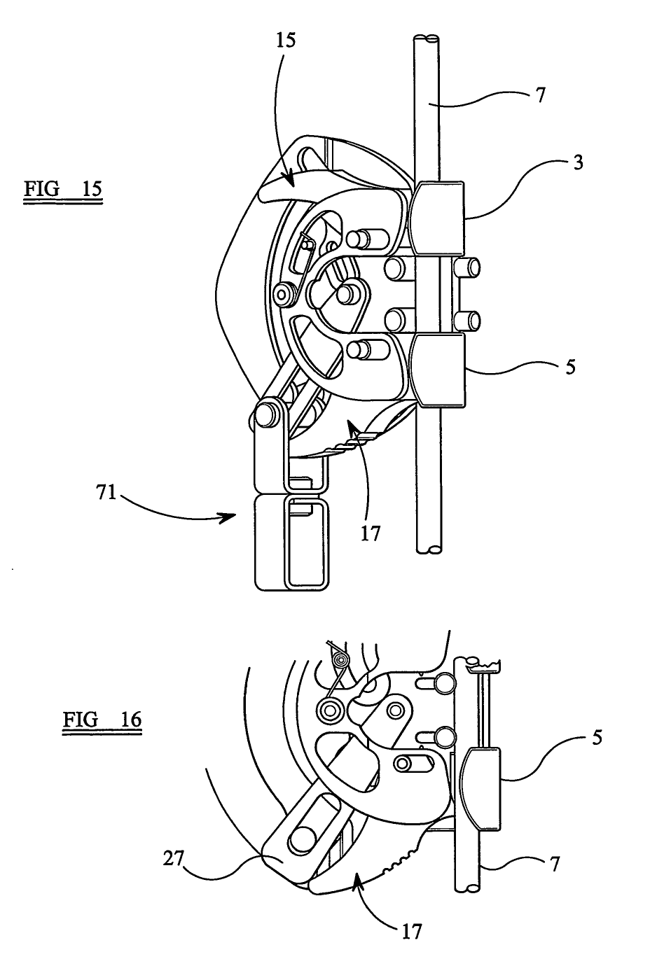

FIG. 15 is a perspective view of the device shown in FIG. 14 with a front plate removed;

FIG. 16 is a front view of part of the device shown in FIG. 15;

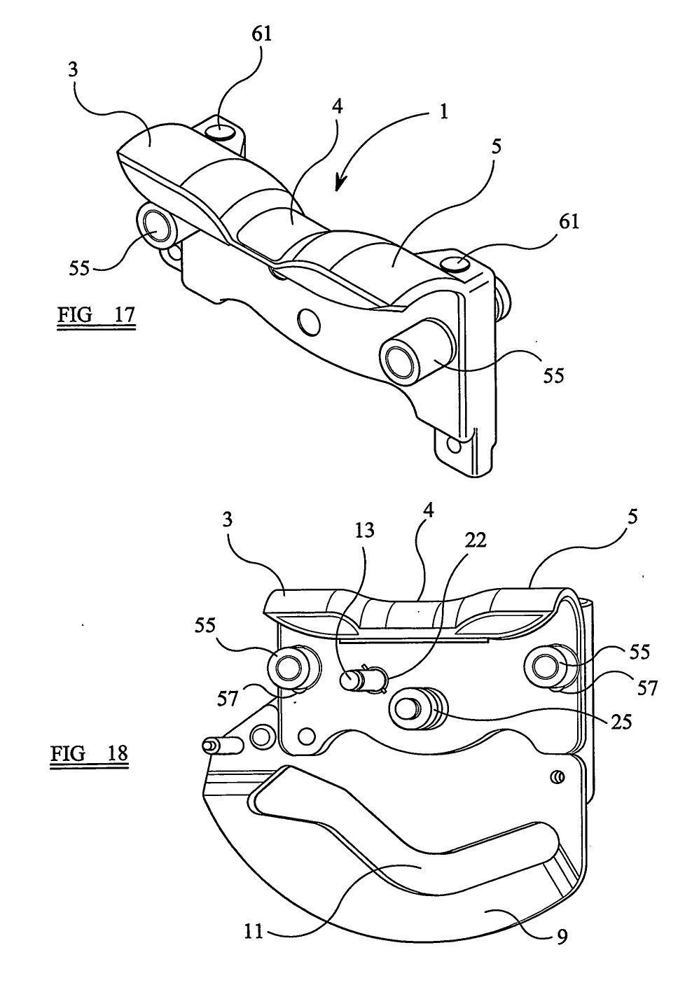

FIG. 17 is a perspective view of a guide block forming part of a further embodiment of a vertical fall arrest device according to the present invention;

FIG. 18 is a view of a back plate added to the guide block of FIG. 17;

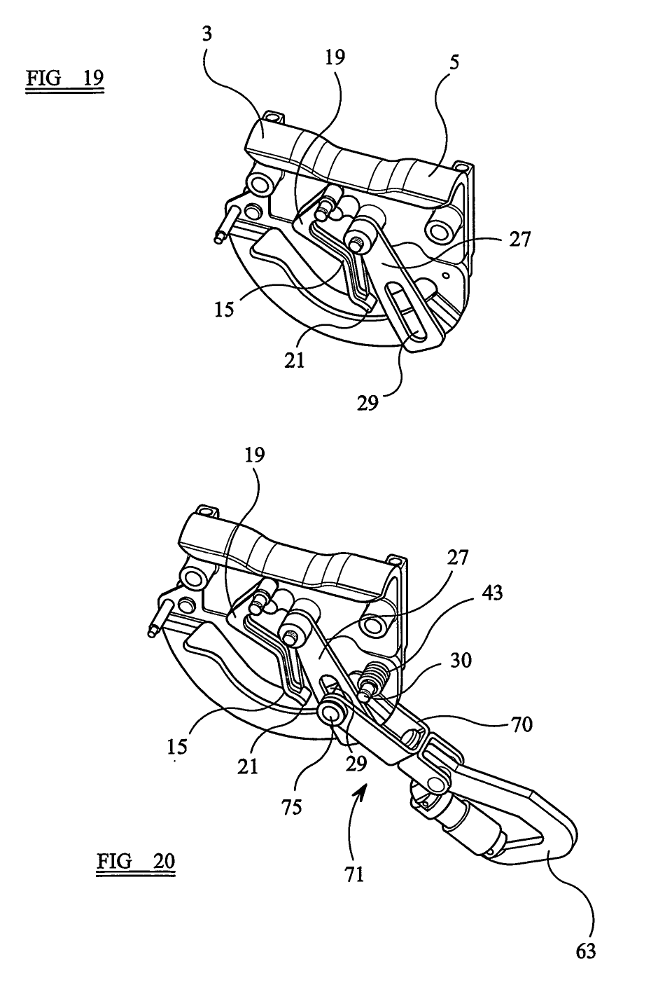

FIG. 19 is a view of the components shown in FIGS. 17 and 18 together with a cam member and a connecting plate;

FIG. 20 is a view of the components shown in FIGS. 17 to 19 together with a connector device;

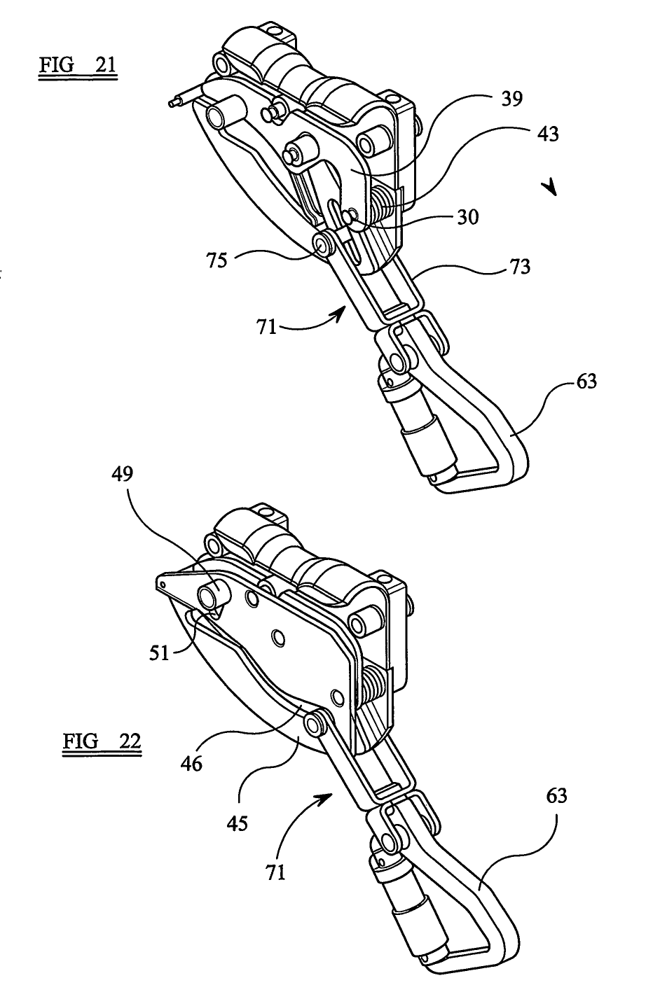

FIG. 21 is a view of the components shown in FIGS. 17 to 20 together with a lock plate;

FIG. 22 is a view of the components shown in FIGS. 17 to 21 together with a front plate;

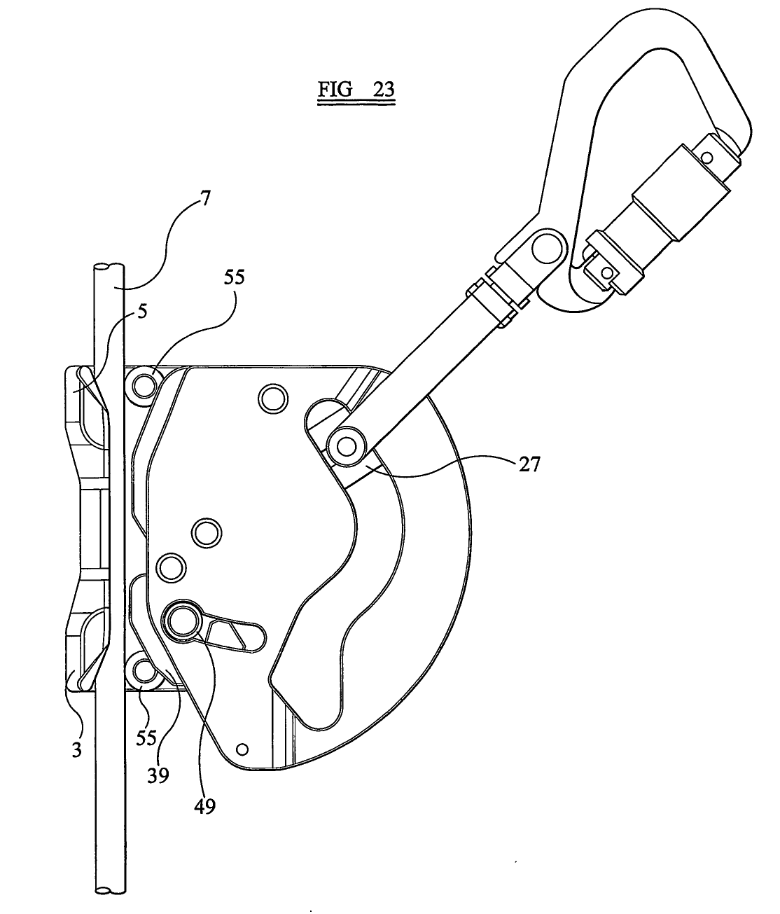

FIG. 23 is a view of the device of FIGS. 17 to 22 is a normal configuration;

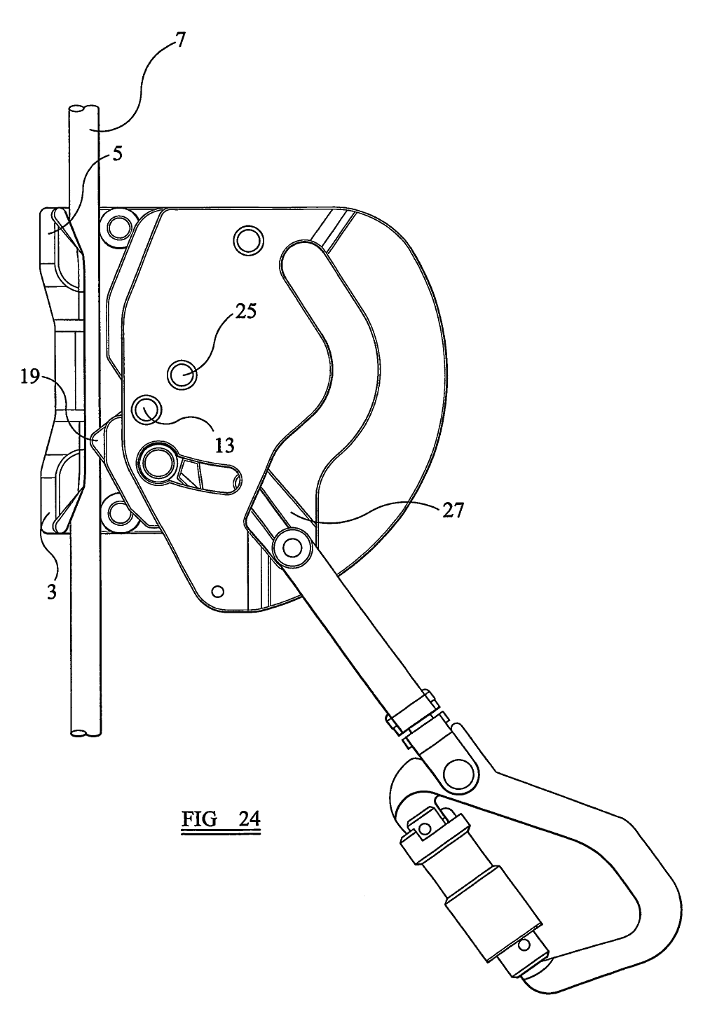

FIG. 24 is a view of the device of FIGS. 17 to 22 in a configuration following a fall;

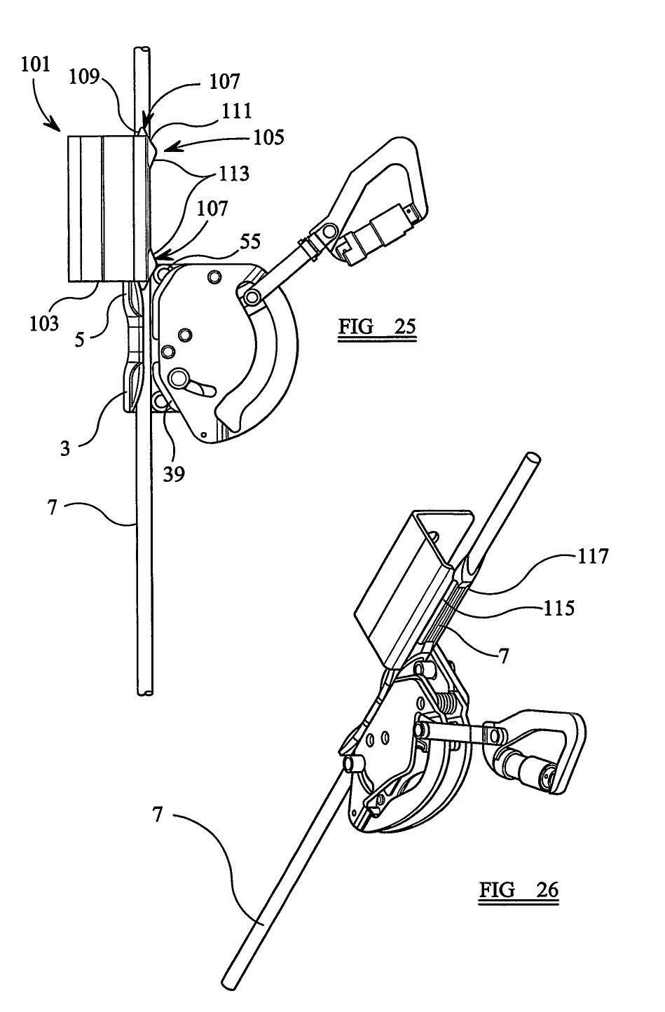

FIG. 25 is an elevational view of the fall arrest device of FIGS. 17 to 22 approaching an intermediate bracket of a fall arrest system according to the present invention;

FIG. 26 is a perspective view corresponding to FIG. 26;

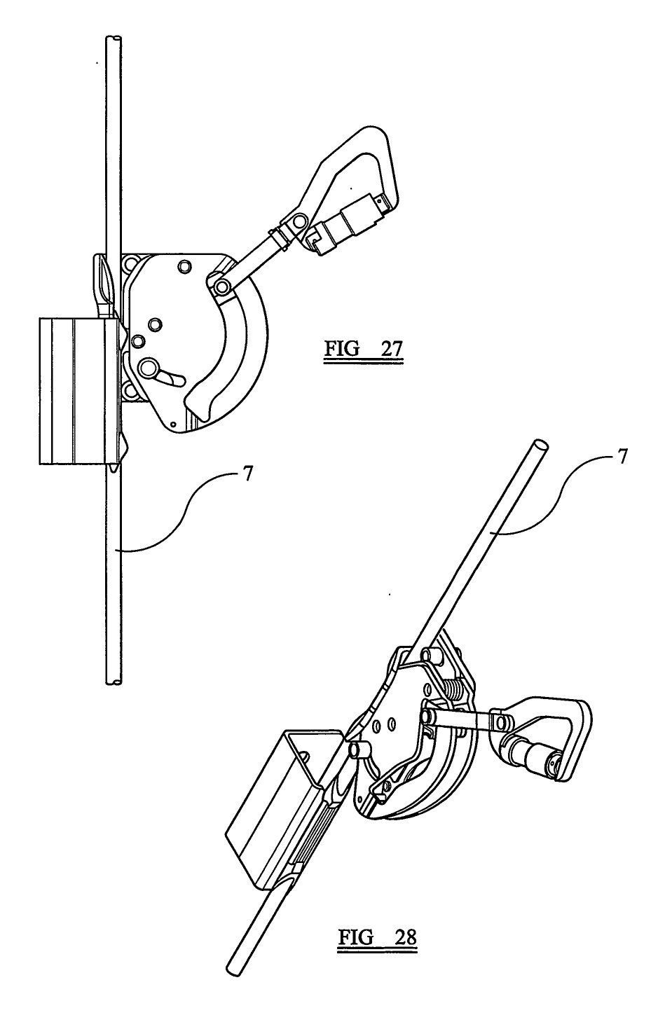

FIG. 27 is an elevational view of the fall arrest device passing the intermediate bracket; and

FIG. 28 is a perspective view of the system after the device has passed the intermediate bracket.

The detachable fall arrest device shown in FIGS. 1 to 9 comprises a guide block 1 which is formed with a pair of spaced U-shaped arms 3, 5 which are spaced in the axial direction of a track in the form of a cable 7 and are adapted to wrap around the cable. The U-shaped arms 3, 5 form a main load bearing part of the device. The guide block 1 is shown in more detail in FIG. 9.

A back plate 9 is secured to the guide block 1, as best shown in FIG. 8. The back plate is provided with an elongate, generally arcuate, aperture 11 for receiving a fastener, such as a karabiner, for securing to a user.

Two cylindrical pegs 13 extend from guide block 1 in a direction perpendicular to the plane of the back plate 9. The pegs 13 are each spaced an equal distance from the top of the internal face of the U-shaped arms 3, 5 and are spaced in the axial direction of the cable 7. A cam member 15, 17 is mounted on each of the pegs 13, the cam member 15 being generally a mirror image of the cam member 17. Each cam member 15, 17 is formed with a cam portion 19 which is adapted to engage with the cable 7 and to lock the cable between the cam portion and the internal surface of the respective U-shaped arm 3, 5 and with an actuating arm 21 which extends in a direction away from the U-shaped arms 3, 5 and terminates at a level within the aperture 11 provided in the back plate 9.

The cam members 15, 17 are pivotably mounted on the pegs 13 and are provided with torsion springs 22 which urge the cam portions 19 of the cam members in a direction away from the top of the internal face of the U-shaped arms 3, 5 until at least a threshold load is applied. Thus, in normal use the cam portions 19 are clear of, and do not engage with, the cable 7 and allow the cable to run freely through the device. Moreover, in normal use the cam portions 19 are a sufficient distance from the U-shaped arms 3, 5 of the guide block 1 to allow the device to be attached to, or detached from, the cable 7.

Extending through a slot 23 formed in the guide block 1 is a further cylindrical peg 25. The slot 23 extends substantially perpendicular to the path of the cable 7 through the device along a line substantially midway between the pegs 13. Pivotably mounted on the peg 25 is an actuating member in the form of a connector plate 27, the connector plate having a length such that an aperture 29 in the region of the free end thereof is positioned within the aperture 11 provided in the back plate 9. In use, the karabiner also passes through the aperture 11.

Two lever arms 31 are also mounted pivotably on the further peg 25 in the region of one end thereof. The lever arms 31 are each provided with a cylindrical peg 33 in the region of the other end thereof, which cylindrical peg 33 engages in an arcuate slot 35 formed in a guide flange in the form of a protrusion 37 extending from each of the cam members 15, 17 towards the other cam member. Thus, movement of the connector plate 27 in a direction away from the cable 7 causes the peg 25 to slide in the slot 23. The lever arms 31 pivot about the peg 25 and the pegs 33 slide in the slots 35 until they reach the end of the slot and then cause the cam members 15, 17 to pivot outwardly. This, in turn, causes the cam portions 19 to move towards the cable 7 and to lock the cable between the cam portions 19 and the internal surface of the U-shaped arms 3, 5 thereby preventing movement of the device relative to the cable.

Mounted over the cam members 15, 17 is a lock plate 39. The lock plate is mounted on the pegs 13 for the cam members by way of elongate slots 41 which extend in a direction substantially perpendicular to the path of the cable 7 through the device. Thus, the lock plate is manually movable in a plane parallel to the back plate 9 and in a direction towards and away from the cable 7. The lock plate 39 is planar and generally U-shaped with generally flat ends to the arms of the U which extend in a direction generally parallel to the path of the cable 7 and generally parallel to the free ends of the U-shaped arms 3, 5 of the guide block 1. When the lock plate is in a position closest to the free ends of the U-shaped arms 3, 5 (as shown in FIG. 1) there is insufficient space between the generally flat ends of the lock plate and the free ends of the U-shaped arms to allow the cable 7 to pass. Whereas, when the lock plate is in a position furthest from the free ends of the U-shaped arms 3, 5 (as shown in FIG. 2) there is sufficient space between the generally flat ends of the lock plate and the free ends of the U-shaped arms to allow the cable 7 to pass into or from the space within the U-shaped arms 3, 5 and for the device to engage with or disengage from the cable. The lock plate 39 is urged in a direction towards the free ends of the U-shaped arms by means of a torsion spring 43.

The lock plate 39 is covered by a front plate 45 of the device, the front plate being in a plane substantially parallel to the plane of the back plate 9 and having an aperture 46 substantially identical to the aperture 11 provided in the back plate 9. In use, the karabiner passes through the aperture 46 in the front plate 45 as well as the aperture 29 in the connector plate 27 and the aperture 11 in the back plate 9.

The front plate is secured to the pegs 13 for the cam members 15, 17 and the peg 25 is slidably retained in an elongate slot 47 which is in alignment with the slot 23 formed in the back plate 9. A lock plate release button 49 is secured to a pin passing through the front plate 45 by way of a slot 51 which extends in the same direction as the slot 47. The lock plate release button 49 can therefore be operated to move the lock plate 39 away from the U-shaped arms 3, 5 against the biasing force of the torsion spring 43 which is secured to the front plate 45 by way of a screw 53.

Two spaced cylindrical friction posts 55 are slidably mounted on the guide block 1 by way of slots 57 provided in the guide block and extending substantially perpendicular to the path of the cable 7 through the device such that the axially extending surface of the posts engages with the cable. The friction posts 55 may be made of steel or a suitable synthetic (e.g., plastics) material. The friction posts 55 are positioned intermediate the further peg 33 and each of the pegs 13. The friction posts 55 are urged in a direction towards the internal surface of the U-shaped arms 3, 5 by means of compression springs 59. The springs 59 exert sufficient force such that in normal use (as shown in FIG. 4) the friction posts 55 are urged against the cable 7 so as to generate sufficient friction between the cable, the friction posts and the internal surface of the U-shaped arms 3, 5 to maintain the device in a stationary position on the cable under its own weight, but which generate a sufficiently low force to allow the device to be readily moved along the cable by the user, for example when a load of less than 5 kg is applied to the device. The required force can readily be determined by the skilled person. The cable can be released from the friction posts 55 by means of a cylindrical release button 61 which is manually movable in a bore extending in the axial direction of each of the slots 57 and engaging with the friction posts 55 where the posts pass through the guide block 1.

When the release buttons 61 are depressed against the biasing force of the compression springs 59, the friction posts 55 are moved away from the internal surface of the U-shaped arms by a sufficient distance to allow the device to be attached to, or detached from, the cable 7.

In use of the detachable fall arrest device shown in FIGS. 1 to 9, the device may be attached to a cable by a user by operating the lock plate release button 49 to move the lock plate 39 away from the U-shaped arms 3, 5 against the biasing force of the spring 43 while simultaneously depressing the release buttons 61 to move the friction posts 55 also away from the U-shaped arms. When both the lock plate release button and the release buttons have been operated the cable can be inserted between the U-shaped arms and the lock plate and friction posts to attach the device to the cable. The lock plate release button 49 and the release buttons 61 can then be released to allow the lock plate 39 to return to its normal position to secure the cable within the path defined by the U-shaped arms 3, 5 and to allow the friction posts 55 to return to their normal positions in which the friction posts and the internal surface of the U-shaped arms 3, 5 apply friction to the cable sufficient to hold the device against its own weight. Thus, the device requires the use of two independent actions before the device can be detached from the cable, thereby avoiding inadvertent disengagement.

The user can then move along the cable 7 and the device will readily follow because the effect of the friction posts is not sufficient to inhibit movement of the device along the cable when pulled.

The device shown in FIGS. 1 to 9 is adapted to lock against the cable and to support the user irrespective of the direction of the fall.

Thus, in the case of a horizontal fall arrest system and the user falling in a direction generally perpendicular to the direction of the cable, the load applied to the connector plate 27 will move the connector plate downwardly as shown in FIG. 4 (that is, in the direction of the slot 23) and the aperture in the connector plate will enter an enlarged region of the apertures 11 and 46 in the back plate 9 and the front plate 45 as shown in FIG. 4. Movement of the connector plate 27 causes the peg 25 to slide in the slot 23 and this, in turn, causes the lever arms 31 to rotate and for the pegs 33 to move in the arcuate slot 35 formed in each of the protrusions 37 forming part of the cam members 15, 17. When the pegs 33 reach the far end of the slots 35 they then urge the cam members to rotate about the pegs 13 and for the actuating arms to move apart. Rotation of the cam members 15, 17 also causes the cam portions 19 to move towards the cable and the internal surface of the U-shaped arms 3, 5 in order to lock the cable between the cam portions and the U-shaped arms and thus to arrest the fall and prevent the user sliding to the centre of a given span of the fall arrest system.

In the case of an inclined or vertical fall arrest system (as illustrated in FIGS. 5 and 7), where the fall arrest system crosses an apex, the friction posts and the locking mechanism will work in both directions of travel. It is therefore not necessary to turn the device around, thereby reducing the risk of injury through error. In the event of the user falling in the general direction of the cable, the load applied to the connector plate 27 will cause the connector plate to rotate about the peg 25 as shown in FIG. 5 towards a vertical orientation (in the case of a downwards fall as shown in FIG. 5). The connector plate 27 directly engages the free end of the actuating arm 21 of the lower cam member 17 and causes the cam member to rotate about the peg 13 outwardly with respect to the device. Rotation of the cam member 17 also causes the cam portion 19 of that cam member to move towards the cable and the internal surface of the U-shaped arm 5 in order to lock the cable between the cam portion and the U-shaped arm and thus to arrest the fall. The arcuate slot 35 in the protrusion 37 of the cam member 17 allows the cam member 17 to rotate unhindered by the lever arm 31.

In the event the device is inverted with respect to that shown in FIGS. 5 and 7, the connector plate 27 directly engages the actuating arm 21 of cam member 15 and causes the cam member to rotate about the peg 13 outwardly with respect to the device. Rotation of the cam member 15 also causes the cam portion 19 of that cam member to move towards the cable and the internal surface of the U-shaped arm 3 in order to lock the cable between the cam portion and the U-shaped arm and thus to arrest the fall. Again, the arcuate slot 35 in the protrusion 37 of the cam member 15 allows the cam member 15 to rotate unhindered by the lever arm 31.

In the case of a structure provided with both vertical and horizontal fall arrest systems, such as a pylon, it will still be necessary for the user to disconnect from one system and re-connect to the other. However, the user can use the same fall arrest device on both the horizontal and the vertical system thereby eliminating the need to carry multiple devices and the risk associated with using the wrong device or the correct device in the wrong orientation.

Thus the fall arrest device described with reference to FIGS. 1 to 9 incorporates a three-way cam system in which each cam actuating mechanism is able to work independently of the others or in combination with the others depending on the direction of the load applied to the device. The device incorporates biasing means which prevents locking of the device to the cable until a threshold load is applied.

The device according to the present invention therefore permits a user to ascend a vertical structure and pass, as required, any intermediate posts without hindrance or the need to manhandle the device. When descending the structure the device will remain above the user's attachment point ensuring, in the event of a slip or a fall, that the user does not experience free fall, thereby preventing trauma and reducing loading on the uppermost termination of the fall arrest system on the structure. In the event the user should stop while descending, the device will remain above the attachment point on the user's body harness, held in place by the friction posts.

The device shown in FIGS. 1 to 9 can clearly be modified in a number of ways. For example, the friction posts may be arranged such that they can be locked in an inactive position. This would have the advantage of allowing the device to move more freely along a horizontal fall arrest system, while the cam mechanism remains effective, and allowing the friction posts to be activated for use on a vertical or inclined fall arrest system.

Although the device has been shown in a form which permits travel past an intermediate post of the fall arrest system, it is readily apparent that the device could be adapted to eliminate this option for use with fall arrest systems which do not incorporate intermediate posts or where it is reasonable to disengage the device to manoeuvre past any intermediate posts.

Although the device has been illustrated with two cam members, a more economical form of the device could be provided with the friction mechanism and only a single cam member. In such a case, however, the device would be effective only on vertical or inclined fall arrest systems and would be effective only in a single direction.

FIG. 10 is a perspective view of the device shown in FIG. 1 together with a karabiner 63 and illustrating the manner in which the device negotiates an intermediate bracket 65 of a fall arrest system. The intermediate bracket comprises a sleeve 67 through which the cable 7 passes and a plate 69 welded to the sleeve in a plane perpendicular to the axis of the cable, the plate 69 being secured by means not shown to a structure on which the fall arrest system is provided. There is sufficient space between the free ends of the U-shaped arms 3, 5 and the adjacent surfaces of the lock plate 39 and front plate 45 to allow the plate 69 to pass therebetween. The ends of the sleeve are chamfered to facilitate entry of the sleeve into the space between the internal surface of the U-shaped arms 3, 5 and the cam portions 19: the friction posts 55, being spring biased, simply move away from the U-shaped arms 3, 5 to allow the sleeve to pass. Moreover, the lower outer regions of the free ends of the U-shaped arms 3, 5 and the outer regions of the lock plate 39 and front plate 45 are curved to form a progressively narrowing opening which creates a lead-in shape that encourages the device to adopt a correct alignment to pass the intermediate bracket 65. Clearly, the intermediate bracket 63 can take numerous forms whilst permitting the device to pass the intermediate bracket in the same general manner.

The device shown in FIG. 11 is modification of the device described above in that a connector device 71 is provided to allow a wide range of fasteners to be employed by the user in addition to the karabiner 63 shown in FIG. 10. The connector device comprises a generally U-shaped member 73 which has a pin 75 passing through apertures formed in the region of the free ends of the U-shaped member. The pin 75 passes through the apertures in the front plate 45, the connector plate 27 and the back plate 9 to secure the connector device 71 to the remainder of the device. A roller 77 is provided on the pin 75 to engage the lower edge of the aperture 46 in the front plate 45 and the lower edge of the aperture 11 in the back plate in order to facilitate movement of the connector plate 27, only the roller for the front plate 45 being shown. A connector member 79 is secured to the U-shaped member 73, for example by riveting or other suitable means, and provides a closed periphery to securely receive a fastener such as a karabiner or other device without the need to pass through the three apertures 11, 29 and 46, thereby simplifying procedures for the user. In other respects, construction and operation of the device is as described hereinabove.

FIG. 12 shows a modification of cam members of the device shown in FIGS. 1 to 9 and also shows a single U-shaped member for receiving the cable. The cam members 81, 83 of the device shown in FIG. 12 are mounted on the back plate 9 as described above, but their actuating arms 85 are positioned adjacent to the peg 25 on which the connector plate (not shown in FIG. 12) is mounted. Moreover, the actuating arms 85 are curved such that the lower ends of the arms are below the peg 25 and are sufficiently close together that downward movement of the peg 25 in the event of a fall causes the arms 85 to separate and the cam members 81, 83 to pivot outwardly thereby causing the cam portions 19 to move towards the cable 7 and to lock the cable between the cam portions and the internal surface of the U-shaped arms 3, 5 thereby preventing movement of the device relative to the cable.

FIG. 13 shows an alternative modification of cam members of the device shown in FIGS. 1 to 9. The cam members 87, 89 of the device shown in FIG. 13 are mounted on the back plate 9 as described above in respect of FIGS. 1 to 9, but their actuating arms have actuating surfaces which are curved inwardly towards their lower and upper ends. The actuating surfaces are also positioned between flanges 91 formed along each longitudinal side of the actuating surfaces. A connector plate 93 is provided on the peg 25 and movable therewith, the connector plate 93 being provided with outwardly inclined lever arms 95 which are securely fastened in position. In the event of a fall in a direction generally perpendicular to the direction of the cable (that is, in a downward direction with respect to FIG. 13), the connector plate 93 and the lever arms move downwardly and cause the actuating arms to separate and the cam members 87, 89 to pivot outwardly thereby causing the cam portions 19 to move towards the cable 7 and to lock the cable between the cam portions and the internal surface of the U-shaped arms 3, 5 thereby preventing movement of the device relative to the cable. In the event of a fall in the direction of the cable 7 the connector plate 93 pivots to engage one of the lever arms 87 or 89 thereby causing the lever arm to pivot and consequently the associated cam portion 19 to move towards the cable 7 and to lock the cable between the cam portion and the internal surface of the U-shaped arms 31 5 thereby preventing movement of the device relative to the cable.

The device shown in FIGS. 14 to 16 is a further alternative modification of the device shown in FIGS. 1 to 9 and incorporates the modification of FIG. 11, the device of FIGS. 14 to 16 being adapted for use with vertical fall arrest systems. In the device of FIGS. 14 to 16, the peg 25 is secured relative to the back plate 9 and the front plate 45. Thus, the connector plate 27 is not able to move away from or towards the cable 7 and can only respond to loads exerted on the device in the general directions of the cable. It should be noted that the apertures 11, 29 and 46 in the back plate 9, connector plate 27 and front plate 45, respectively, is of a different configuration to that shown in FIGS. 1 to 9 in that it is relatively narrow and of substantially constant width and curvature. The apertures also differ in another respect inasmuch as the end regions are linear and extend generally in the direction of the cable. Movement in this direction is accommodated by providing an elongate aperture in the connector plate 27. The portions of the apertures in the end regions of the plates need not be parallel to the direction of the cable, but an angle not more than thirty degrees is advantageous. In this way the load created by a fall is more effectively transmitted to the actuating arm 21 of the cam member and is not borne by an inclined edge of the apertures and consequently causes the cam portion 19 to lock more effectively against the cable 7.

The lever arms 31 are not required in the embodiment of FIGS. 14 to 16 and are therefore not shown. Further, the protrusions 37 on the cam members 15, 17 are not necessary, but may be provided to allow one component to be employed in a number of different devices. Operation of the device shown in FIGS. 14 to 16 is essentially the same as the operation of the device shown in FIGS. 1 to 9 in an inclined or vertical fall arrest system.

The embodiment shown in FIGS. 17 to 24 illustrates a vertical fall arrest device similar to the device shown in FIGS. 1 to 9. The same references are used to denote the same or similar components.

Thus the device comprises a guide block 1 which is formed with a pair of spaced U-shaped arms 3, 5 with an intermediate member 4 filling the space between the arms 3, 5.

As can be seen from FIG. 18, a backplate 9 is secured to the guide block 1 and is provided with an elongate, generally arcuate, aperture 11 which is of substantially constant width and curvature except for an end region at the clockwise end of the aperture (as shown in the figures) which is linear and extends generally in the direction of the cable.

A cylindrical peg 13 extends from the guide block 1 in a direction perpendicular to the plane of the backplate 9. A cam member 15 is mounted on the peg 13 and is formed with a cam portion 19 which is adapted to engage with cable 7 (see FIGS. 23 and 24) and to lock the cable between the cam portion 19 and the U-shaped arm 3. Cam member 15 is also formed with an actuating arm 21 which extends in a direction away from the U-shaped arms 3, 5 and terminates at a level substantially within the aperture 11 provided in the back plate 9.

The cam member 15 is pivotably mounted on the peg 13 and is provided with a torsion spring (22) which urges the cam portion in a direction away from the top of the internal face of the U-shaped arm 3 until at least a threshold load is applied. Thus, in normal use the cam portion 19 is clear of, and does not engage with, the cable and allows the cable to run freely through the device. Moreover, in normal use the cam portion 19 is a sufficient distance from the U-shaped arm 3 of the guide block to allow the device to be attached to, or detached from, the cable.

A further cylindrical peg 25 also extends from the guide block 1 and an actuating member in the form of a connector plate 27 is pivotably mounted on the peg 25. The connector plate has a length such that an aperture 29 in the region of the free end thereof is positioned within the aperture 11 provided in the back plate. The aperture is elongate in the longitudinal direction of the connector plate. A connector device 71 is provided in the form of a generally U-shaped member 73 which has a pin 75 passing through apertures in the region of the free ends of the U-shaped member. The pin 75 passes through the apertures in a front plate 45 (FIG. 22), the connector plate 27 and the back plate 9 to secure the connector device to the remainder of the device. A karabiner 63 is provided at the free end of the connector device 71.

Pivotably mounted on a peg 30 which extends from the backplate 9 in a direction substantially perpendicular to the plane of the backplate is a lock plate 39. The lock plate is urged in the direction of the free ends of the U-shaped arms 3, 5 by means of a torsion spring 43. The lock plate 39 is movable in a plane parallel to the back plate 9 and in a direction towards and away from the cable. The lock plate is planar and has a generally linear edge which extends in a direction generally parallel to the path of the cable through the device and generally parallel to the free ends of the U-shaped arms 3, 5. The lock plate is provided with an arcuate slot centred about peg 30 to allow movement of the lock plate relative to the peg 25. When the lock plate is pivoted to a position closest to the free ends of the U-shaped arms 3, 5 (as shown in FIG. 21) there is insufficient space between the generally linear edge of the lock plate and the free ends of the U-shaped arms to allow the cable to pass. However, when the lock plate is pivoted to a position furthest from the free ends of the U-shaped arms there is sufficient space between the generally linear edge of the lock plate and the free ends of the U-shaped arms to allow the cable to pass into or from the space within the U-shaped arms and for the device to engage with or disengage from the cable.

The lock plate 39 is covered by a front plate 45 of the device, the front plate being in a plane substantially parallel to the plane of the back plate 9 and having an aperture 46 substantially identical to the aperture 11 provided in the back plate 9. The front plate 45 is planar and has a generally linear edge which extends in a direction generally parallel to the path of the cable through the device and generally parallel to the free ends of the U-shaped arms 3, 5. The linear edge of the front plate is spaced a sufficient distance from the free ends of the U-shaped arms to allow the cable to pass.

The front plate 45 is secured to the pegs 13, 25 and 30, while a lock plate release button 49 is secured to a pin passing through the front plate 45 by way of an arcuate slot 51 having a radius of curvature centred on the peg 30. As will be explained in more detail hereinafter, the lock plate release button 49 can be operated to move the lock plate 39 away from the U-shaped arms 3, 5 against the biasing force of the torsion spring 43.

Two spaced cylindrical friction posts 55 are slidably mounted on the guide block 1 by way of slots 57 provided in the guide block and extending substantially perpendicular to the path of the cable through the device such that the axially extending surface of the posts engages in use with the cable. In contrast to the device of FIGS. 1 to 9, the friction posts are provided adjacent each end of the guide block 1. The friction posts are urged in a direction towards the internal surface of the U-shaped arms as previously explained in relation to FIGS. 1 to 9. The compression or other springs forming the biasing means exert sufficient force such that in normal use the friction posts are urged against the cable so as to generate sufficient friction between the cable, the friction posts and the internal surface of the U-shaped arms to maintain the device in a stationary position on the cable under its own weight, but which generate a sufficiently low friction force to allow the device to be readily moved along the cable by the user, for example when a load of less than 5 kg is applied to the device. The required force can be readily determined by the skilled person. The cable can be released from the friction posts 55 by means of a cylindrical release button 61 which is manually movable in a bore extending in the axial direction of each of the slots 57 and engaging with the friction posts 55 where the posts pass through the guide block 1.

When the release buttons 61 are depressed against the biasing force of the compression springs, the friction posts are moved away from the internal surface of the U-shaped arms 3, 5 by a sufficient distance to allow the device to be attached to, or detached from, the cable.

In operation, with the connector plate 27 pointing generally upwards in the configuration shown in FIG. 23 the device may be attached to a generally vertical cable 7 by a user operating the lock plate release button 49 to move the lock plate 39 away from the U-shaped arms 3, 5 against the biasing force of the spring 43 while simultaneously depressing the release buttons 61 to move the friction posts 55 also away from the U-shaped arms. When both the lock plate release button and the release buttons have been operated, the cable can be inserted between the U-shaped arms and the lock plate and friction posts to attach the device to the cable. The lock plate release button 49 and the release buttons 61 can then be released to allow the lock plate 39 to return to its normal position to secure the cable within the path defined by the U-shaped arms 3, 5 and to allow the friction posts 55 to return to their normal positions in which the friction posts and the internal surface of the U-shaped arms 3, 5 apply friction to the cable sufficient to hold the device against its own weight. Thus the device requires the use of two independent actions before it can be detached from the cable, thereby avoiding inadvertent disengagement.

The user can then move upwardly or downwardly along the cable 7 and the device will readily follow because the effect of the friction posts 55 is not sufficient to inhibit movement of the device along the cable when pulled.

The locking mechanism comes into operation in the event of a fall. Should a fall occur the load applied to the connector plate 27 will cause the connector plate to rotate about the peg 25 as shown in FIG. 24 towards a generally downward configuration. The connector plate directly engages the free end of the actuating arm 21 of the cam member 15 and causes the cam member to rotate about the peg 13 in an clockwise direction as shown in the figures. Rotation of the cam member also causes the cam portion 19 to move towards the cable and the internal surface of the U-shaped arm 3 in order to lock the cable between the cam portion and the U-shaped arm and thus to arrest the fall.

It should be noted that the profile of the lock plate 39 is such that pivoting thereof about the peg 13 is only possible when the connector plate 27 is substantially at the anticlockwise end (as shown in the figures) of the aperture 11. In other positions of the connector plate 27, the lock plate 39 engages against the connector plate should any attempt be made to pivot the lock plate. Thus the device can only be engaged with or disengaged from the cable when the connector plate is substantially at the anticlockwise end of the aperture 11.

It has been found that when the intermediate bracket is in the form of a solid cylindrical tube which may be chamfered or tapered at the ends thereof, the resulting fall arrest system when employed with a fall arrest device as described with reference to the drawings can give rise to difficulties. For example, the friction posts generate less friction when in contact with the tube of the intermediate bracket than when in contact with the cable. It has been found that the fall arrest device of the present invention operates more satisfactorily with an intermediate bracket 101 of the form shown in FIGS. 25 to 28.

The intermediate bracket 101 shown in FIGS. 25 to 28 incorporates a conventional supporting plate 103 for securing the intermediate bracket to a suitable supporting surface and a cable engaging member 105 secured to the supporting plate 103.

The supporting plate 103 is dimensioned to pass between the free ends of the U-shaped arms 3, 5 and the lock plate 39.

The cable engaging member 105 is formed at each axial end thereof with an end portion 107 of substantially triangular configuration when viewed in a direction substantially perpendicular to the plane of the back plate 9 with the apex of the triangle outermost with regard to the intermediate bracket. Thus, the end portion is provided with divergent faces 109, 111 one of which engages with one of the friction posts 55 and the other of which engages with the internal surface of the U-shaped arm 5 of the fall arrest device to urge the friction post in a direction away from the U-shaped arms 3, 5 and to allow the fall arrest device to begin to traverse the intermediate bracket.

It should be noted, of course, that the fall arrest device can in practice traverse the intermediate bracket in either direction.

The faces 109, 111 of the end portion diverge to a maximum dimension and then inner faces converge (only convergent face 113 is shown in the drawings) such that a portion of the cable 7 is exposed for engagement with the friction posts 55, cam portion(s) 19 and preferably also for engagement with the internal faces of the U-shaped arms 3, 5.

The end portions 107 are interconnected by lateral connecting portions 115, 117 at the each side of the cable and at the sides of the end portions when looking in a plane substantially parallel to the plane of the back plate 9.

In contrast to a conventional substantially cylindrical cable engaging member, the cable engaging member 105 facilitates passage of the friction posts 55 over the end portion of the intermediate bracket and allows the friction posts, the cam portion(s) and the internal faces of the U-shaped arms to engage with the cable itself rather than with the smooth cylindrical surface of the cable engaging member for a substantial proportion of the longitudinal extent of the intermediate bracket, thereby increasing the friction between the friction posts and the cable to maintain the fall arrest device in position and increasing the friction between the cam portion(s) and the cable for increased effectiveness in the event of a fall as the fall arrest device is traversing an intermediate bracket.

1. A fall arrest device characterised comprising:
a U-shaped member (3, 5) adapted to accommodate a track (7) of a fall arrest system;
a cam member (15, 17; 81, 83; 87, 89) including an actuating arm (21; 85) and a cam portion (19), the cam member being pivotably mounted on the device such that the cam portion is movable towards the U-shaped member so as to lock the track between the cam portion and an internal surface of the U-shaped member in the event of a fall;
biasing means (22) urging the cam member in a direction away from the internal surface of the U-shaped member to a position in which the cam portion is adapted to allow the track to pass between the cam portion and the internal surface of the U-shaped member;
actuating means (27; 93) adapted in the event of a fall to engage with the actuating arm or the cam member and to cause the cam member to pivot against the biasing force of the biasing means such that the cam portion locks the track;
friction means (55) adapted in use to engage with the track such that at least a predetermined minimum load is required to cause the device to move relative to the track; and
a lock plate (39) which is movable towards and away from the path of the track (7) through the device, the lock plate including biasing means (43) adapted to bias the plate to a position in which it co-operates with the U-shaped member (3, 5) to prevent the device being removed from the track.

2. A device as claimed in claim 1, wherein two U-shaped members (3, 5) are provided, the U-shaped members being spaced in the axial direction of the path of a track (7) through the device.

3. A device as claimed in claim 1, wherein the actuating arm (85) of the cam member (81, 83) is provided with guide flanges (91) for the actuating means (27).

4. A device as claimed in claim 1, wherein the device includes two cam members (15, 17; 81, 83; 87, 89), the cam members being adapted to be actuated by movement of the actuating means (27; 93) in generally opposing directions.

5. A device as claimed in claim 1, wherein the biasing means (22) comprises a torsion spring.

6. A device as claimed in claim 1, wherein the biasing means (22) is adapted to maintain the cam member (15, 17; 81, 83; 87, 89) in position until a threshold load is applied thereto.

7. A device as claimed in claim 1, wherein the actuating means (27; 93) is pivotably mounted on the device.

8. A device as claimed in claim 1, wherein the actuating means (27; 93) is movable in a direction towards and away from the path of the track (7) through the device.

9. A device as claimed in claim 8, wherein the actuating means (27; 93) is movable in a direction substantially perpendicular to the path of the track (7).

10. A device as claimed in claim 1, wherein the actuating means (27; 93) includes a lever (31; 95) adapted to engage the cam member (15, 17; 87, 89).

11. A device as claimed in claim 10, wherein the lever (31) is slidably engaged with an arcuate slot (35) provided in the cam member (15, 17).

12. A device as claimed in claim 1, wherein the actuating means (27) engages directly with the cam member (15, 17).

13. A device as claimed in claim 1, wherein the actuating means (27; 93) is provided with an aperture (29) for receiving fastening means (63; 71) for securing a user to the device.

14. A device as claimed in claim 13, wherein the device includes a plate (9, 45) extending in a plane substantially parallel to the actuating means (27; 93) and provided with an aperture (11, 46) for receiving the fastening means (63; 71).

15. A device as claimed in claim 14, wherein two spaced plates (9, 45) are provided, one plate being positioned on either side of the actuating means (27).

16. A device as claimed in claim 14, wherein the aperture (11, 46) in the plate (9, 45) is curved.

17. A device as claimed in claim 16, wherein the aperture (11, 46) in the plate (9, 45) includes a portion at least at one end thereof extending in a direction substantially parallel to the axial direction of the path of the track (7) through the device.

18. A device as claimed in claim 14, wherein an intermediate member (71) is provided, the intermediate member extending through the aperture (29) in the actuating means (27) and through the aperture (11, 46) in the or each plate (9, 45), for connecting to a fastening means (63).

19. A device as claimed in 1 claim 1, wherein the friction means (55) comprises a cylindrical post, the axially extending surface of the post being adapted to engage the track (7).

20. A device as claimed in claim 19, wherein two cylindrical posts (55) are provided, the posts being spaced in the axial direction of the path of the track (7) through the device.

21. A device as claimed in claim 20, wherein the cylindrical posts (55) are in the region of opposite ends of the device.

22. A device as claimed in claim 1, wherein the friction means (55) is movable towards and away from the path of the track (7).

23. A device as claimed in claim 1, wherein the friction means (55) is adapted to exert a force on the track (7) such that a predetermined minimum load is required to move the device relative to the track.

24. A device as claimed in claim 23, wherein the predetermined load corresponds to a load less than 5 kg.

25. A device as claimed in claim 23, wherein the predetermined load corresponds to a load greater than the weight of the device.

26. A device as claimed in claim 1, wherein the friction means (55) includes means (59) biasing the friction means towards the path of the track (7).

27. A device as claimed in claim 26, wherein the biasing means (59) comprises a compression spring.

28. A device as claimed in claim 1, wherein the friction means (55) comprises means (61) for (manually) moving the friction means away from the path of the track (7).

29. A device as claimed in claim 28, wherein the means for moving the friction means (55) comprises a release button (61).

30. (canceled)

31. A device as claimed in claim 1, wherein the lock plate (39) is spaced from the U-shaped member (3, 5) in the locking position to allow the device to pass over intermediate posts of the fall arrest system.

32. A device as claimed in claim 1, wherein the biasing means (43) of the lock plate (39) comprises a torsion spring.

33. A device as claimed in claim 1, wherein the lock plate (39) includes a release button (49) for moving the lock plate in a direction away from the U-shaped member (3, 5) against the force of the biasing means (43).

34. A fall arrest system comprising a track (7), an intermediate bracket (65, 101) and a device as claimed in claim 1, wherein the intermediate bracket (65, 101) is formed intermediate end portions thereof with inclined faces whereby a portion of the track is exposed intermediate the end portions for engagement with the friction means (55) and with the cam portion (19) of the fall arrest device.

35. A system as claimed in claim 34, wherein the track (7) is in the form of a cable.

36. A system as claimed in claim 34, wherein the intermediate bracket (101) is formed intermediate end portions thereof with inclined faces whereby a portion of the track (7) intermediate the end portions is exposed for engagement with the internal surface of the U-shaped member (3, 5) of the fall arrest device.

37. A system as claimed in claim 36, wherein the end portions of the intermediate bracket (101) are interconnected by means lateral connecting portions provided at each side of the track.

38. A system as claimed in claim 36, wherein the end portions of the intermediate bracket (101) are formed with divergent faces, one of which faces is adapted to engage the friction means (55) and the other of which faces is adapted to engage the internal surface of the U-shaped member (3, 5).
